(19) United States
(12) Patent Application Publication
(10) Pub. No.: US 2026/0239283 A1
(43) Pub. Date: Aug. 13, 2026

(54) METHOD AND APPARATUS FOR PROOF-OF-COVERAGE

(71) Applicant: QUALCOMM Incorporated, San Diego, CA (US)

(72) Inventors: Sunghoon KIM, San Diego, CA (US); Haris ZISIMOPOULOS, London (GB); Lenaig Genevieve CHAPONNIERE, La Jolla, CA (US); Sebastian SPEICHER, Wallisellen (CH); Soo Bum LEE, San Diego, CA (US); Yogesh TUGNAWAT, San Diego, CA (US); Junyi LI, Greentown, PA (US); Hua WANG, Basking Ridge, NJ (US)

(21) Appl. No.: 19/160,011

(22) PCT Filed: Mar. 19, 2024
(86) PCT No.: PCT/US2024/020604

§ 371 Date: Aug. 26, 2025

(30) Foreign Application Priority Data
Apr. 11, 2023 (GR) 20230100314

(51) Int. Cl. H04W 64/00; H04B 17/318; H04W 56/00; H04W 84/04; H04W 92/18

(52) U.S. Cl. CPC H04W 64/00; H04B 17/328; H04W 56/0015; H04W 84/042; H04W 92/18

(57) ABSTRACT

Disclosed are systems and techniques for wireless communications. For instance, a process may include receiving configuration information for wireless coverage verification, receiving a neutral host token, receiving a broadcast message from a neutral host node, measuring at least the broadcast message from the neutral host node to obtain radio information, generating a coverage report based on the radio information, and outputting the coverage report and neutral host token to a network function.

### FIELD

The present disclosure generally relates to wireless communications. For example, aspects of the present disclosure relate to systems and techniques for selecting and configuring user equipment (UE) for proof of coverage (POC) and policies for POC.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments.

Although wireless communication systems have made great technological advancements over many years, challenges still exist. For example, complex and dynamic environments can still attenuate or block signals between wireless transmitters and wireless receivers, undermining a coverage areas. In such areas, wireless devices may not be able to access the wireless network. In some cases, these areas may be difficult for traditional wireless network providers to access to provide additional coverage. To help improve and/or expand wireless networks, it may be useful to allow individuals to obtain and setup small wireless networks that may be accessible by wireless devices.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing wireless communications. In one illustrative example, an apparatus for wireless communications is provided that includes at least one memory and at least one processor (e.g., implemented in circuitry) coupled to the at least one memory. The at least one processor is configured to: receive configuration information for wireless coverage verification; receive a neutral host token; receive a broadcast message from a neutral host node; measure at least the broadcast message from the neutral host node to obtain radio information; generate a coverage report based on the radio information; and output the coverage report and neutral host token to a network function.

As another example, an apparatus for wireless communications is provided. The apparatus includes: at least one memory comprising instructions; and at least one processor coupled to the at least one memory and configured to: receive, from a network function, a verification code and sidelink configuration information; receive a sidelink transmission, the sidelink transmission from an active user equipment (UE), the sidelink transmission including the verification code; measure the sidelink transmission to obtain sidelink radio information measurements; generate a coverage report, the coverage report including the sidelink radio information measurements and verification code; and output the coverage report to the network function.

In another example, an apparatus for wireless communications is provided. The apparatus includes: at least one memory comprising instructions; and at least one processor coupled to the at least one memory and configured to: enter a connected mode with a neutral host node; receive a verification code, the verification code generated by a network entity; receive sidelink configuration information; and transmit a sidelink message based on the sidelink configuration information, the sidelink message including the verification code.

As another example, an apparatus for wireless communications is provided. The apparatus includes: at least one memory comprising instructions; and at least one processor coupled to the at least one memory and configured to: receive a neutral host token from a network function; and transmit a broadcast message, the broadcast message including the neutral host token.

In another example, an apparatus for wireless communications is provided. The apparatus includes: at least one memory comprising instructions; and at least one processor coupled to the at least one memory and configured to: receive a neutral host token and a set of valid user equipment (UE) tokens from a network function; transmit a broadcast message; receive, in response to the broadcast message, a first radio access channel (RACH) message from a UE, the first RACH message including a UE token; authenticate the UE based on a comparison of the UE token with the set of valid UE tokens; transmit, based on authenticating the UE, a second RACH message including the neutral host token; receive a coverage report from the UE; and output the coverage report to the network function.

As another example, a method for wireless communications is provided. The method includes: receiving configuration information for wireless coverage verification; receiving a neutral host token; receiving a broadcast message from a neutral host node; measuring at least the broadcast message from the neutral host node to obtain radio information; generating a coverage report based on the radio information; and outputting the coverage report and neutral host token to a network function.

In another example, a method for wireless communications is provided. The method includes receiving, from a network function, a verification code and sidelink configuration information; receiving a sidelink transmission, the sidelink transmission from an active user equipment (UE), the sidelink transmission including the verification code; measuring the sidelink transmission to obtain sidelink radio information measurements; generating a coverage report, the coverage report including the sidelink radio information measurements and verification code; and outputting the coverage report to the network function.

As another example, a method for wireless communications is provided. The method includes entering a connected mode with a neutral host node; receiving a verification code, the verification code generated by a network entity: receiving sidelink configuration information; and transmitting a sidelink message based on the sidelink configuration information, the sidelink message including the verification code.

In another example, a method for wireless communications is provided. The method includes receiving a neutral host token from a network function; and transmitting a broadcast message, the broadcast message including the neutral host token

As another example, a method for wireless communications is provided. The method includes receiving a neutral host token and a set of valid user equipment (UE) tokens from a network function; transmitting a broadcast message; receiving, in response to the broadcast message, a first radio access channel (RACH) message from a UE, the first RACH message including a UE token; authenticating the UE based on a comparison of the UE token with the set of valid UE tokens; transmitting, based on authenticating the UE, a second RACH message including the neutral host token; receiving a coverage report from the UE; and outputting the coverage report to the network function.

In another example, a non-transitory computer-readable medium having stored thereon instructions is provided. The instructions, when executed by one or more processors, cause the at one or more processors to receive configuration information for wireless coverage verification; receive a neutral host token; receive a broadcast message from a neutral host node; measure at least the broadcast message from the neutral host node to obtain radio information; generate a coverage report based on the radio information; and output the coverage report and neutral host token to a network function.

As another example, a non-transitory computer-readable medium having stored thereon instructions is provided. The instructions, when executed by one or more processors, cause the at one or more processors to receive, from a network function, a verification code and sidelink configuration information; receive a sidelink transmission, the sidelink transmission from an active user equipment (UE), the sidelink transmission including the verification code; measure the sidelink transmission to obtain sidelink radio information measurements; generate a coverage report, the coverage report including the sidelink radio information measurements and verification code; and output the coverage report to the network function.

In another example, a non-transitory computer-readable medium having stored thereon instructions is provided. The instructions, when executed by one or more processors, cause the at one or more processors to enter a connected mode with a neutral host node; receive a verification code, the verification code generated by a network entity; receive sidelink configuration information; and transmit a sidelink message based on the sidelink configuration information, the sidelink message including the verification code.

As another example, a non-transitory computer-readable medium having stored thereon instructions is provided. The instructions, when executed by one or more processors, cause the at one or more processors to receive a neutral host token from a network function; and transmit a broadcast message, the broadcast message including the neutral host token.

In another example, a non-transitory computer-readable medium having stored thereon instructions is provided. The instructions, when executed by one or more processors, cause the at one or more processors to receive a neutral host token and a set of valid user equipment (UE) tokens from a network function; transmit a broadcast message; receive, in response to the broadcast message, a first radio access channel (RACH) message from a UE, the first RACH message including a UE token; authenticate the UE based on a comparison of the UE token with the set of valid UE tokens; transmit, based on authenticating the UE, a second RACH message including the neutral host token; receive a coverage report from the UE; and output the coverage report to the network function.

As another example, an apparatus for wireless communications is provided. The apparatus includes means for receiving configuration information for wireless coverage verification; means for receiving a neutral host token; means for receiving a broadcast message from a neutral host node; means for measuring at least the broadcast message from the neutral host node to obtain radio information; means for generating a coverage report based on the radio information; and means for outputting the coverage report and neutral host token to a network function.

In another example, an apparatus for wireless communications is provided. The apparatus includes means for receiving, from a network function, a verification code and sidelink configuration information; means for receiving a sidelink transmission, the sidelink transmission from an active user equipment (UE), the sidelink transmission including the verification code; means for measuring the sidelink transmission to obtain sidelink radio information measurements; means for generating a coverage report, the coverage report including the sidelink radio information measurements and verification code; and means for outputting the coverage report to the network function.

As another example, an apparatus for wireless communications is provided. The apparatus includes means for entering a connected mode with a neutral host node; means for receiving a verification code, the verification code generated by a network entity; means for receiving sidelink configuration information; and means for transmitting a sidelink message based on the sidelink configuration information, the sidelink message including the verification code.

In another example, an apparatus for wireless communications is provided. The apparatus includes means for receiving a neutral host token from a network function; and means for transmitting a broadcast message, the broadcast message including the neutral host token

As another example, an apparatus for wireless communications is provided. The apparatus includes means for receiving a neutral host token and a set of valid user equipment (UE) tokens from a network function; means for transmitting a broadcast message; means for receiving, in response to the broadcast message, a first radio access channel (RACH) message from a UE, the first RACH message including a UE token; means for authenticating the UE based on a comparison of the UE token with the set of valid UE tokens; means for transmitting, based on authenticating the UE, a second RACH message including the neutral host token; means for receiving a coverage report from the UE; and means for outputting the coverage report to the network function.

In some aspects, one or more of the apparatuses described herein is, is a part of, or includes a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIGS. 5A-5D depict various example aspects of data structures for a wireless communication network, in accordance with some examples;

FIG. 6 is a conceptual network diagram illustrating an example of a small cellular network and wholesale provider, in accordance with aspects of the present disclosure;

FIG. 7 is an architectural diagram illustrating an example of a wireless network supporting PoC, in accordance with aspects of the present disclosure;

FIG. 8 is a sequence diagram illustrating an example layer one witnessing operation, in accordance with aspects of the present disclosure;

FIG. 9 is a sequence diagram illustrating an example layer two witnessing operation, in accordance with aspects of the present disclosure;

FIG. 10 is a block diagram illustrating an example sidelink (SL) assisted witnessing operation, in accordance with aspects of the present disclosure;

FIG. 11 is a block diagram illustrating an example direct connectivity assisted witnessing operation, in accordance with aspects of the present disclosure;

FIG. 12 is a flow diagram of a process for verifying coverage in wireless systems, in accordance with aspects of the present disclosure;

FIG. 13 is a flow diagram of a process for verifying coverage in wireless systems, in accordance with aspects of the present disclosure;

FIG. 14 is a flow diagram of a process for verifying coverage in wireless systems, in accordance with aspects of the present disclosure;

FIG. 15 is a flow diagram of a process for verifying coverage in wireless systems, in accordance with aspects of the present disclosure;

FIG. 16 is a flow diagram of a process for verifying coverage in wireless systems, in accordance with aspects of the present disclosure;

FIG. 17 is a diagram illustrating an example of a computing system, according to aspects of the disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Increasingly, large mobile network operator (MNO) have been struggling with adding cellular infrastructure, such as small cells, to improve cellular coverage. For example, certain large neighborhoods may prohibit infrastructure to be built within the neighborhood, such as cellular towers and as a result, cellular coverage within the neighborhood may be relatively poor. To help improve and/or expand cellular coverage, it may be useful to allow individuals to obtain and setup small cellular networks. However, management of a cellular network may be more difficult that what most individuals would want to and/or be capable of performing, it may be useful to allow the small cellular networks to be managed by a central authority. In some cases, large MNOs may not be set up to work with individuals to provide management for many small cellular networks. Rather, a wholesale provider may work with individuals to setup, configure, and/or manage the small cellular networks. In some cases, assurance that that individuals have setup and are running small cellular networks may be useful.

Systems, apparatuses, electronic devices, methods (also referred to as processes), and computer-readable media (collectively referred to herein as “systems and techniques”) are described herein for providing to a proof of coverage (PoC) of small cellular networks. In some cases, PoC may be used to ensure a neutral host network, such as one setup by an individual, is operating properly at an expected location. In some cases, PoC may be separate from a proof of usage. In some cases, PoC may be provided by one or more witness UEs (W-UEs). In some cases, the W-UEs may be configured by a PoC network function to verify PoC of a neutral host node. The neutral host node may be a small cell device, such as a small base station, femtocell, picocell, and the like, that may be owned and/or set up by a party separate from a wireless network operator (e.g., party operating a core network). The W-UEs may receive a neutral host token associated with the neutral host node. The neutral host token may be a digital token (e.g., a unique set of values) that can be used to determine whether the neutral host network is providing wireless coverage that is available to UEs of the wireless network operator. The W-UE may also receive a broadcast message, such as a SIB, from the neutral host node. In some cases, the SIB may include the neutral host token. In other cases, the W-UE may response to the SIB and receive, in response, the neutral host token. The W-UE may generate a PoC report by monitoring transmissions from the neutral host. The PoC report may include the neutral host token. The W-UE may then transmit the PoC report to the neutral host.

Additional aspects of the present disclosure are described in more detail below.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3GPP gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

In some aspects, wireless communications networks may be implemented using one or more modulation schemes. For example, a wireless communication network may be implemented using a quadrature amplitude modulation (QAM) scheme such as 16QAM, 32QAM, 64QAM, etc.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

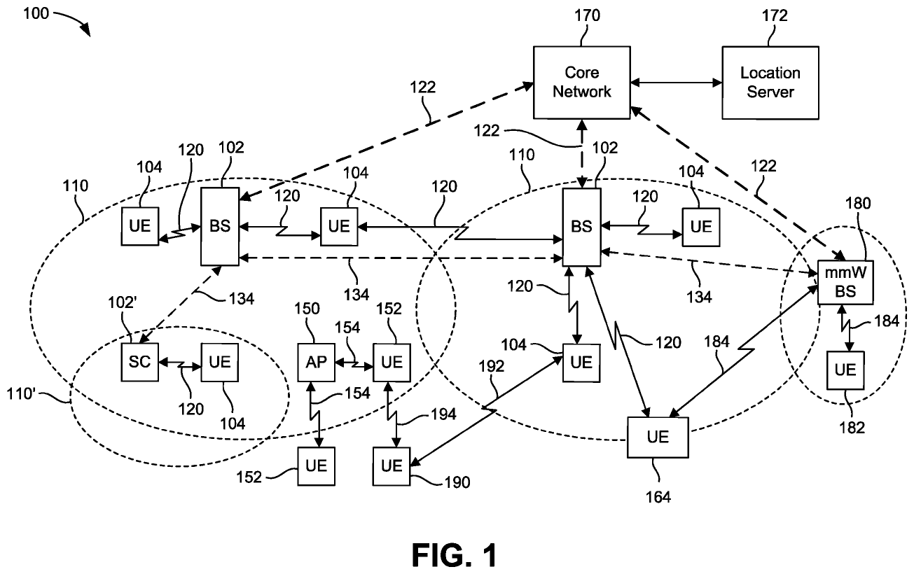

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHZ.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FRI) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D 2D RAT, such as 5G direct mode, LTE Direct (LTE-D), Wi-Fi Direct (Wi-Fi-D), Bluetooth®, and so on.

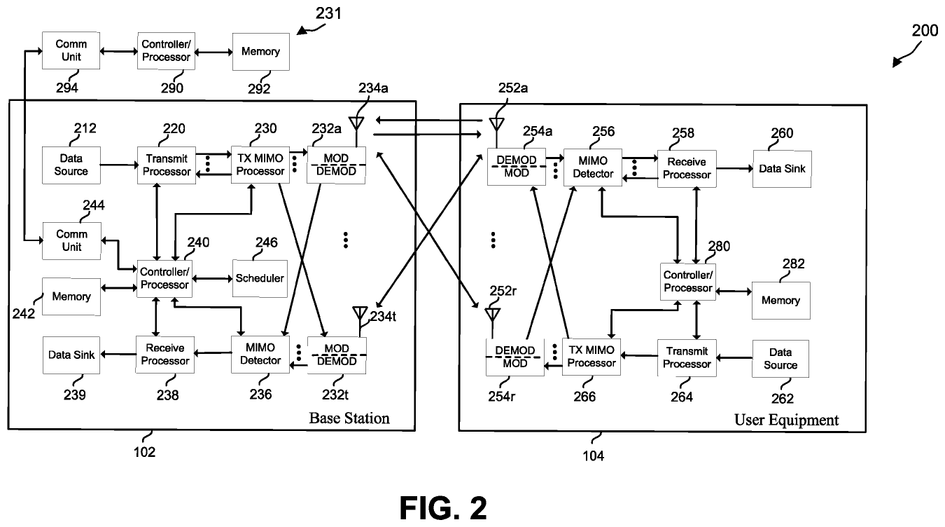

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234 a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

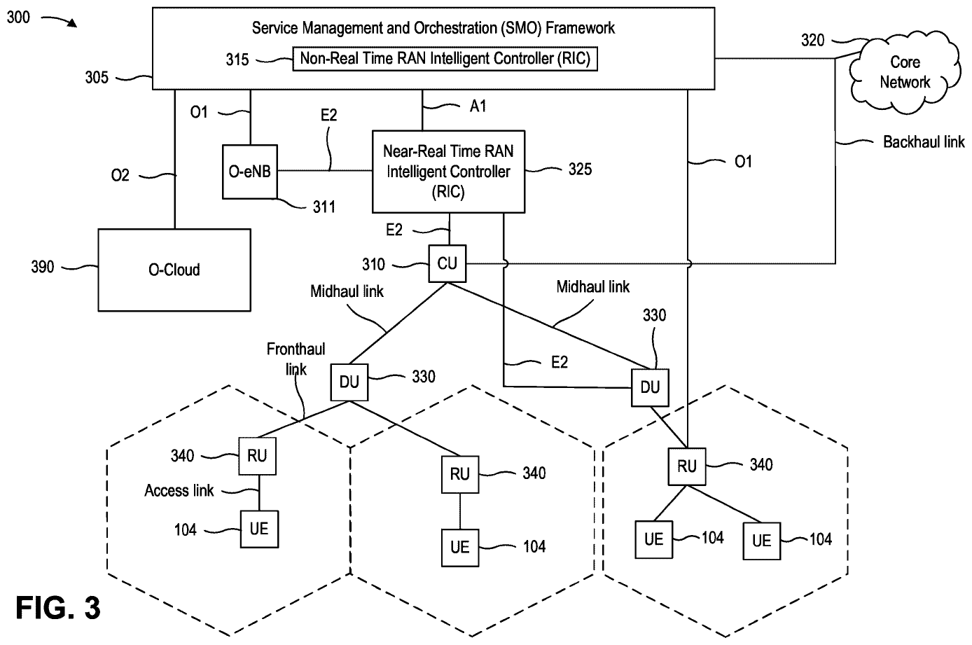

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies). Network functions may be independent services hosted on a network, such as the core network 320, which provide functionality for the network. Examples of network functions may include an access and mobility function (AMF), which provides an entry point for UE connections, authentication server function (AUSF), which provides authentication services for authenticating UEs, user plane function (UPF), which provides IP traffic support, and the like.

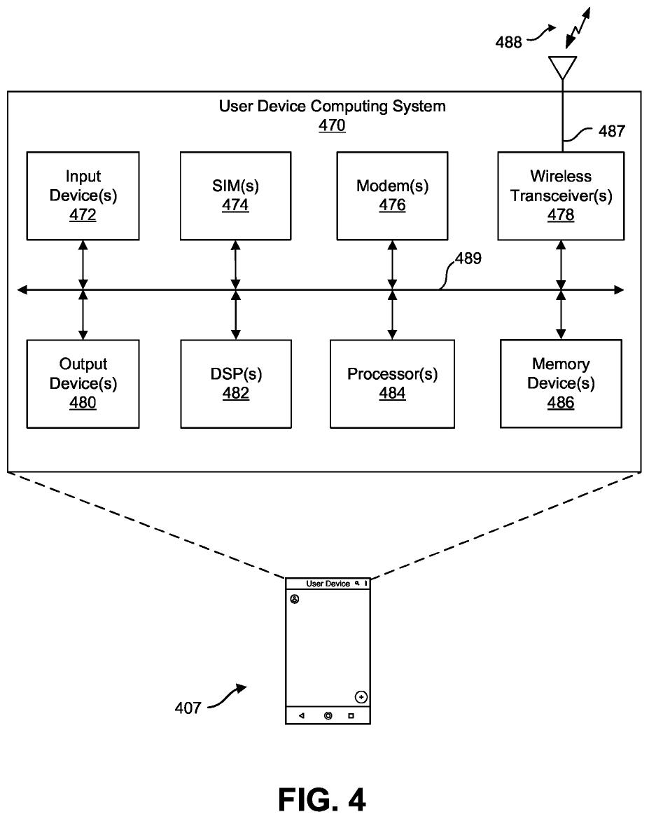

FIG. 4 illustrates an example of a computing system 470 of a wireless device 407. The wireless device 407 may include a client device such as a UE (e.g., UE 104, STA 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IOT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

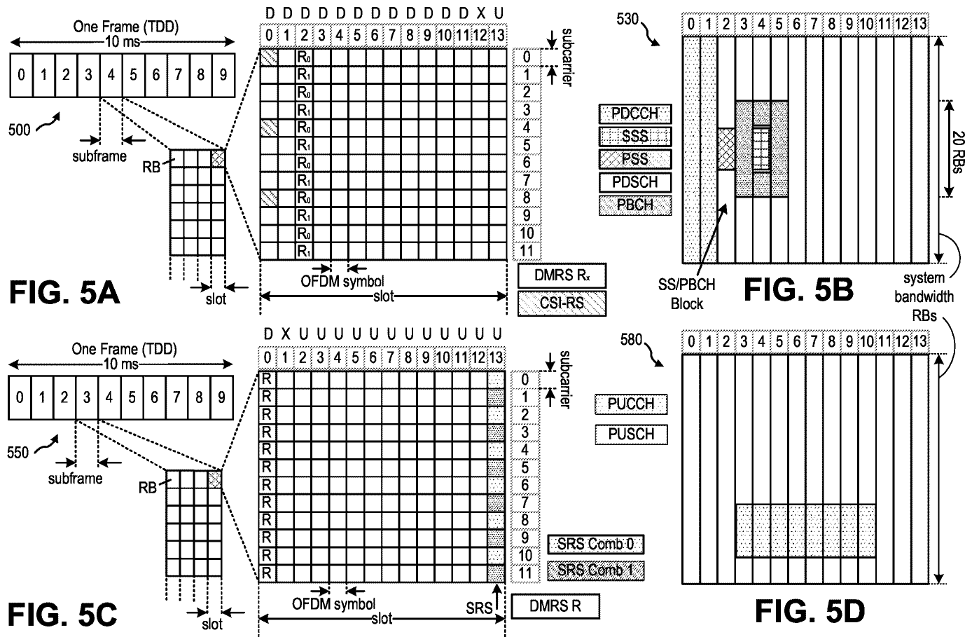

FIGS. 5A-5D depict various example aspects of data structures for a wireless communication system, such as wireless communication system 100 of FIG. 1. FIGS. 5A-5D depict aspects of data structures for a wireless communication network, such as wireless communication network 100 of FIG. 1. In particular, FIG. 5A is a diagram 500 illustrating an example of a first subframe within a 5G (e.g., 5G NR) frame structure, FIG. 5B is a diagram 530 illustrating an example of DL channels within a 5G subframe, FIG. 5C is a diagram 550 illustrating an example of a second subframe within a 5G frame structure, and FIG. 5D is a diagram 580 illustrating an example of UL channels within a 5G subframe.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 5A and 5C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μu, there are 14 symbols/slot and 2 μslots/subframe. The subcarrier spacing and symbol length/duration are a function of the numerology. The subcarrier spacing may be equal to 2^{μ×}15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 5A-5D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 5A, some of the REs carry reference (pilot) signals (RS) for a UE (e.g., UE 104, STA 152, UE 190). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 5B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., UE 104, STA 152, UE 190) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 5C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 5D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

In some cases, a UE may not be connected from a wireless network (e.g., when there is no NAS signaling connection between the UE and the wireless network). For example, a UE may just have been powered up, the UE may exit from an airplane mode, the UE enters a new service area, RRC reconfiguration, handover, and the like. This disconnected UE may be in an idle state and the UE may listen for wireless networks. After the UE identifies a wireless network, the UE may then attempt to connect to the wireless network. In some cases, the UE may attempt to connect to the wireless network via a wireless node to establish an RRC connection.

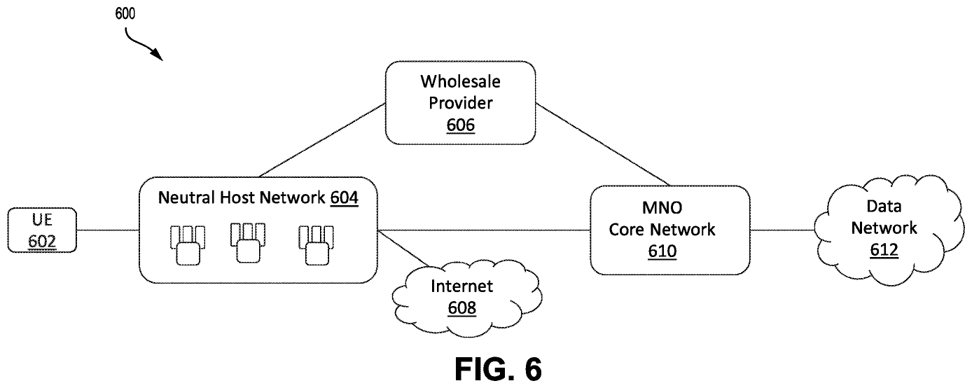

FIG. 6 is a conceptual network diagram illustrating an example 600 of a small cellular network and wholesale provider, in accordance with aspects of the present disclosure. In example 600, a UE 602 may connect to a neutral host network 604, which may be a wireless network provided by a neutral host, such as an individual. For example, an individual may purchase and setup a small cell device as a neutral host network 604. The neutral host network 604 may be compliant with applicable standard and spectrum regulations and the individual may become a small cellular network provider. In some cases, the neutral host network 604 may offer access to the internet 608, and a UE 602 may be able to access the internet 608 via an internet connection made available by the neutral host network 604. The neutral host network 604 may also be coupled to one or more MNO core networks 610, through which MNO services, such as voice calls, messaging services, and the like may be accessed via data network 612.

Rather than individuals working directly with a MNO, the individuals may work with a wholesale provider 606. The wholesale provider 606 may have roaming agreements with one or more MNOs and the wholesale provider 606 may provide infrastructure support for the neutral host network 604. This infrastructure support may include assisting individual setup, configure, and/or manage the neutral host network 604.

In some cases, the wholesale provider 606 may also provide ledger, data credit management, and/or settlement services. For example, UE 602 may have a service plan with a MNO that provides them access to neutral host networks, such as neutral host network 604, working with the MNO via the wholesale provider 606. The wholesale provider 606 may then charge the MNO a fee for the coverage extension and data offloading (e.g., roaming) services provided by the neutral host network 604. As another example, UE 602 may have a subscription to a wholesale provider 606 and the wholesale provider 606 may reward (e.g., credit) the neutral host network 604 based the coverage extension provided by the neutral host network 604 and/or on usage by UE 602. In some cases, a trusted system for tracking a coverage provided by the neutral host network 604 may be useful to ensure that the neutral host network 604 is providing service and coverage extension in an expected area to allow a UE 602 to obtain cellular coverage and service from the MNO in the expected area. For example, it may be useful to have some mechanism to detect and/or neutralize where a fraudulent neutral host network 604 is set up to only provide services to a captive UE 602. In some cases, proof-of-coverage (PoC) may be used to ensure a neutral host network 604 is operating properly at an expected location. In some cases, PoC may be separate from a proof of usage.

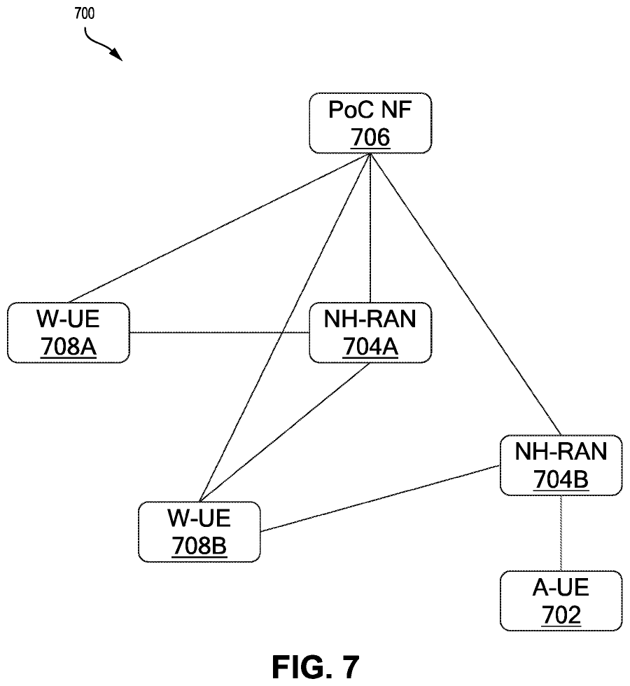

FIG. 7 is an architectural diagram illustrating an example of a wireless network 700 supporting PoC, in accordance with aspects of the present disclosure. In the wireless network 700, an active UE (A-UE) 702 may be a UE camping on (e.g., in a connected mode where the UE may be connected to a wireless network and performing activities such as monitoring for paging by the wireless network, monitoring control channels, performing cell measurements, and the like) and be served by a neutral host radio access network (NH-RAN) 704B. In some cases, the A-UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IOT) device, etc., that may be used by a user to communicate over a wireless communications network of a neutral host network, such as NH-RAN 704B. The NH-RANs 704A, 704B (collectively NH-RANs 704) may be substantially similar to neutral host network 604 of FIG. 6. In some cases, the NH-RANs 704 may function in a manner similar to a small cell and the A-UE 702 may connect to and access the NH-RAN 704B in a manner substantially similar to a small cell. In some cases, the NH-RANs 704 may support performing PoC operations at an access stratum (AS) layer. As an example of PoC operations, the NH-RANs 704 may execute one or more processes which collect PoC data from witnesses UEs (W-UEs) 708A, 708B (collectively W-UEs 708). The NH-RANs 704 may also report collected PoC data to a PoC network function (NF) 706.

In some cases, the W-UEs 708 may be either dedicated UEs for performing witnessing operations, or any UE. In some cases, the W-UEs 708 may not need to be registered with an MNO supported by the NH-RANs 704. Rather the W-UEs 708 may be registered with other MNO. In some cases, the W-UEs 708 may need to join (e.g., register, enroll, subscribe, etc.) with the wholesale provider associated with the NH-RANs 704 to perform witnessing operations for the wholesale provider. In some cases, A-UEs, such as A-UE 702, may function as W-UEs 708.

In cases where the W-UEs 708 may be any UE, the W-UEs 708 may perform witnessing operations while the W-UEs 708 are in an idle mode on a different serving MNO. In some cases, the W-UEs 708, while in the idle mode on the serving MNO and performing witnessing operations on the NH-RANs 704, may be available to receive paging messages from the serving MNO as needed. For example, the W-UE may perform an idle mode autonomous tune away procedure to read a system information block (SIB1) broadcast by the NH-RANs 704 to obtain information for the witnessing operation, in a manner similar to that performed for multi-subscriber identity module (SIM) scenarios. Based on information received from the NH-RANs 704, such as the SIB 1, the W-UEs 708 may generate PoC data. For example, W-UE 708B may receive transmissions from NH-RAN 704B and generate PoC data regarding NH-RAN 704B. After the PoC data is generated, the W-UEs 708 may send the PoC data to the PoC NF 706. The PoC NF 706 may collect PoC data from W-UEs 708 and or from NH-RANs 704. In some cases, the PoC operations (e.g., generating and sending PoC data) may be performed at the AS layer of the UE. In some cases, the PoC data may be sent via the serving MNO or through a NH-RAN 704 to the PoC NF 706. In some cases, the PoC NF 706 may be hosted on a network of the wholesale provider, such as wholesale provider 606 of FIG. 6. The PoC NF 706 may also configured PoC related information to the NH-RANs 704 and/or W-UEs 708. In some cases, the W-UEs 708 may receive a reward for performing witnessing operations.

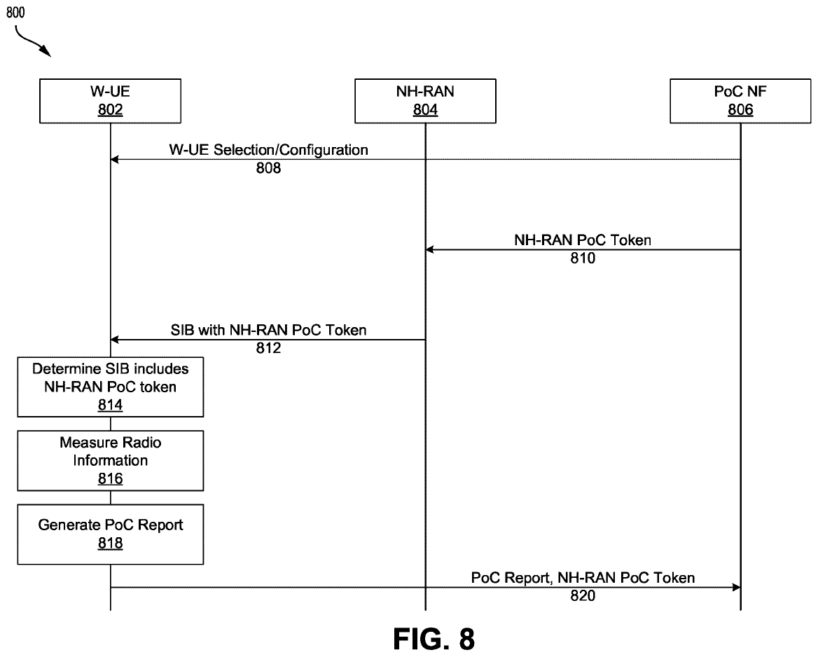

FIG. 8 is a sequence diagram illustrating an example layer one witnessing operation 800, in accordance with aspects of the present disclosure. Witnessing operation 800 may be a layer one (e.g., physical layer) solution as the witnessing may be performed based on physical layer operations, such as by monitoring SIB broadcasts. In witnessing operation 800, a W-UE 802 may perform PoC witnessing operations on a NH-RAN 804 (e.g., a NH-RAN node) and report to a PoC NF 806. The W-UE 802 may be registered with the PoC NF 806 to provide PoC witnessing services. The PoC NF 806 may select and configure the W-UE 802 to perform PoC witnessing for NH-RAN 804 based on a location of the W-UE 802 and a location of the NH-RAN 804. For example, the PoC NF 806 may select W-UE 802 to perform PoC witnessing as W-UE 802 is near NH-RAN 804. The PoC NF 806 may, at step 808, transmit an indication to W-UE 802 indicating that W-UE 802 has been selected to perform PoC witnessing, along with configuration information for the PoC witnessing (e.g., configuration information for wireless coverage verification). The configuration information may include information about a radio frequency to monitor, public land mobile network (PLMN) ID, cell ID, a maximum allowed time window for the PoC report, an offset time for subsequent PoC reports, and any combination thereof, and/or other information.

In some cases, selection of a W-UE 802 by the PoC NF 806 may be useful to help avoid fraudulent W-UE 802 farming operations. In some cases, W-UE's near an expected location of the NH-RAN 804 may be selected to perform PoC witnessing by either selecting W-UE's on, for example, a city or neighborhood level and configuring them to perform PoC witnessing, or by configuring a large number W-UE's and configuring them to perform PoC witnessing. To avoid scenarios where a fraudulent user maintains a large number of potential W-UEs near a particular NH-RAN 804 in an attempt to get those potential W-UEs selected to perform PoC witnessing, the PoC NF 806 may maintain lists of W-UEs commonly selected, grade W-UEs which perform PoC witnessing, determine whether a W-UE may be suspicious or untrusted, maintain lists of untrusted or trusted W-UEs, and then select W-UEs based on the lists/grades/determinations, etc.

In some cases, the PoC NF 806 may assign, at step 810, a NH-RAN PoC token to the NH-RAN 804. The NH-RAN PoC token may include a unique value assigned to the NH-RAN 804 for PoC witnessing operations. In some cases, an initial NH-RAN PoC token may be allocated to the NH-RAN 804 during a registration, onboarding and/or configuration procedure for the NH-RAN 804 where the NH-RAN 804 is prepared for use. In some cases, the PoC NF may, from time to time (e.g., periodically, after a partially random time period, and the like) assign, at step 810, the NH-RAN 804 a refreshed/updated NH-RAN PoC token value. Refreshing/updating the NH-RAN PoC token value may help avoid the NH-RAN PoC token being copied and used elsewhere.

During operation, the NH-RAN 804 may, at step 812, transmit SIB broadcasts including the NH-RAN PoC token. In some cases, the SIB may be transmitted periodically by the NH-RAN 804. In other cases, the SIB may be transmitted on demand (e.g., in response to a request by a UE, such as the W-UE 802) by the NH-RAN 804. In some cases, the SIB may be based on an existing SIB message format. In other cases, a new SIB message format and/or new DL broadcast channel may be used, for example, if the NH-RAN PoC token exceeds existing SIB or synchronization signal block (SSB) size limitations.

After a W-UE 802 receives the transmitted SIB, the W-UE 802 may, at step 814, determine whether the SIB includes the NH-RAN PoC token. If the SIB includes the NH-RAN PoC token, the W-UE 802 may determine to perform radio information measuring for the PoC witnessing operation. The W-UE 802 may, at step 816, measure radio information of the NH-RAN 804. In some cases, the radio information may include information such as a RSRP of the NH-RAN 804, SSB information, cell ID, PLMN ID, and the like. In some cases, the measurements may be based on information in the SIB or may be measurements made on other transmissions from the NH-RAN 804. Based on the measurements, the W-UE 802 may generate a PoC report (e.g., coverage report) about the NH-RAN 804. In some cases, the PoC report may include the measured RSRP, SSB information, cell ID, PLMN ID, NH-RAN PoC token, and the like, along with a time stamp and a location of the W-UE 802. The location of the W-UE 802 may be based on Global Navigation Satellite System (GNSS) information, or other location information, such as a cellular location or information about nearby wireless stations, such as BS, APs, and the like. The PoC report (which may include the NH-RAN PoC token) may, at step 820, be transmitted to the PoC NF 806. In some cases, the PoC report may be transmitted over a secured IP connection between the W-UE 802 and the PoC NF 806. This secured connection may be an IP connection that is separate from the NH-RAN 804, such as a Wi-Fi connection, separate serving cell, and/or another radio access technology. In some cases, the W-UE 802 may use a user plane protocol (e.g., via an application programming interface, HTTP, and the like) to transfer the PoC report to the PoC NF 806 via the separate IP connection. In operation 800, the W-UE 802 may not have a user plane connection to the PoC NF 806 via the NH-RAN 804. If the W-UE 802 is connected to the NH-RAN 804, then the W-UE 802 would be an active UE on the NH-RAN 804, rather than a W-UE 802.

In some cases, the W-UE 802 may be configured (e.g., at step 808) with a maximum allowed time window for the PoC report. This maximum allowed time window (e.g., time delay) may be a maximum amount of time after the PoC witnessing operation performed (or after the PoC report is generated) when the W-UE 802 may transmit the PoC report to the PoC NF 806. If the W-UE 802 transmits the PoC report to the PoC NF 806 after the maximum time window, then verification of the PoC witnessing operation may fail. In some cases, the time reference may be based on a SIB, such as a SIB9, broadcast by the NH-RAN 804 which may include information related to Global Navigation Satellite System (GNSS) time and/or coordinated universal time (UTC). The W-UE 802 may receive the SIB9 from the NH-RAN 804 to obtain the time reference for the PoC report that is transmitted to the PoC NF 806. Once the PoC NF 806 receives the PoC report, the PoC NF 806 may verify that the PoC report was received within the maximum time window based on the time reference in the PoC report. In some cases, PoC reports received outside of the maximum time window may be dropped as the PoC reports may potentially be unreliable and/or no longer relevant.

In some cases, the whether the W-UE 802 is reporting within the maximum time window may be verified based on a verification code. In some cases, the verification code may be generated using a root value and a current time. The PoC NF 806 may send the root value to the NH-RAN 804 and the NH-RAN 804 may generate the verification code. The NH-RAN 804 may transmit the verification code along with the NH-RAN PoC token to the W-UE 802 (e.g., via SIB). The NH-RAN may then include the verification code in the PoC report. The verification code may change periodically and the PoC NF 806 may verify, using the verification code, whether the PoC report was received within the maximum time window.

In some cases, the W-UE 802 may be configured (e.g., at step 808) with an offset time for subsequent PoC reports. In some cases, a W-UE 802 may remain nearby a NH-RAN 804 for a relatively long period of time. In such cases, it may be useful to limit a number of times the W-UE 802 performs PoC witnessing of the NH-RAN 804, for example to avoid possible PoC report farming. After transmitting a PoC report regarding a NH-RAN 804, the W-UE 802 may wait an amount of time based on the offset time before transmitting another PoC report for the same NH-RAN 804.

In some cases, the NH-RAN PoC token may be specific to an NH-RAN 804 node. The PoC NF 806 may allocate the NH-RAN PoC token for a specific NH-RAN 804 and the PoC NF 806 may periodically refresh the NH-RAN PoC token. In some cases, the PoC report time may be limited for PoC data reliability and concurrency (e.g., reports from multiple W-UEs for a NH-RAN 804) can increase data reliability.

In some cases, the NH-RAN PoC token may be specific to one or more particular W-UE 802. In some cases, the PoC NF 806 may allocate the NH-RAN PoC token for monitoring by one specific W-UE 802. The NH-RAN PoC token may be any random number generated by the PoC NF 806. Where the NH-RAN PoC token is allocated for one specific W-UE 802, only a PoC report from the one specific W-UE 802 may be valid and eligible for a reward. In cases where the NH-RAN PoC token is specific to a group of W-UEs, the NH-RAN PoC token may be encrypted. The W-UEs of the group may be provisioned (e.g., during step 808) with a key to decrypt the encrypted NH-RAN PoC token. In some cases, the NH-RAN PoC token may include an identifier for the group of W-UEs. The decrypted NH-RAN POC token may be included in the PoC report.

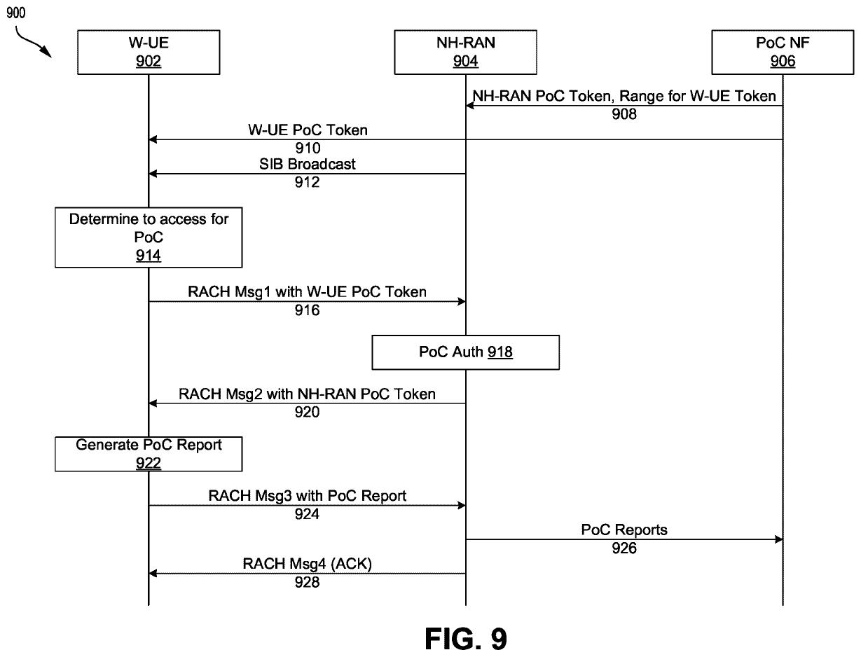

FIG. 9 is a sequence diagram illustrating an example layer two witnessing operation 900, in accordance with aspects of the present disclosure. Witnessing operation 900 may be a layer two (e.g., medium access control (MAC) layer) solution as the witnessing may be performed based on MAC layer operations, such as by using messages for initially accessing a wireless network (e.g., initial access messages), such as RACH messages. In witnessing operation 900, a W-UE 902 may perform PoC witnessing operations on a NH-RAN 904 (e.g., a NH-RAN node) and report to a PoC NF 906. The W-UE 902 may be registered with the PoC NF 906 to provide PoC witnessing services. In witnessing operation 900, the W-UE 902 may access resources of the NH-RAN 904 to report to the PoC NF 906. In some cases, the W-UE 902 may access the NH-RAN 904 using a W-UE PoC token. The W-UE PoC token may include a unique value that may be used by the W-UE to access the NH-RAN 904 and for PoC witnessing.

In some cases, the PoC NF 906 may assign, at step 908, a NH-RAN PoC token to the NH-RAN 904 along with a range of W-UE tokens. A W-UE token may be a digital token that can be used by a UE (e.g., UE token) for accessing a network, such as NH-RAN 904. The range of W-UE tokens may indicate a set of valid W-UE tokens to the NH-RAN 904. In a manner similar to that discussed above with respect to FIG. 8, an initial NH-RAN PoC token and initial range of W-UE tokens may be allocated during a registration procedure and refreshed from time to time.

In some cases, as the PoC report may be forwarded by the NH-RAN 904 using resources of the NH-RAN 904 where the W-UE 902 does not have a subscription/account/access for connectivity via NH-RAN 904, the W-UE PoC token may be used to allow the NH-RAN 904 to authenticate/validate the W-UE 902. In some cases, as the PoC NF 906 may provide, to the NH-RAN 904, information to verify the W-UE PoC token by providing an indication of a set of valid W-UE tokens. In some cases, the indication of the set of valid W-UE tokens may be list of valid W-UE token values or one or more ranges of valid W-UE token values. In some cases, the W-UE token may be a one-time use token and may be a random number. In other cases, if the W-UE token may be reused, the token may be computed (e.g., at the W-UE 902 and NH-RAN 904) based on a key provided by the PoC NF 906. In some cases, the token may include a plaintext token ID, a count, and a hash of the token ID, the count, and/or other input parameters. In some cases, the W-UE PoC token may be UE specific. In some cases, the NH-RAN PoC token used for layer two PoC witnessing operations may be substantially similar to the NH-RAN PoC token used for layer one PoC witnessing operations discussed above with respect to FIG. 8.

The PoC NF 906 may select the W-UE 902 to perform PoC witnessing for NH-RAN 904 in a substantially similar manner to that discussed above with respect to FIG. 8. The PoC NF 806 may, at step 910, transmit an indication to W-UE 902 indicating that W-UE 902 has been selected to perform PoC witnessing, along with configuration information for the PoC witnessing, and the W-UE PoC token. The PoC NF 806 may also transmit security materials, such as an encryption key, to the W-UE for use to secure a PoC report. As discussed above, the configuration information may include information about a radio frequency to monitor, public land mobile network (PLMN) ID, cell ID, a maximum allowed time window for the PoC report, an offset time for subsequent PoC reports, and the like.

In some cases, the NH-RAN 904 may, at step 912, transmit SIB broadcasts. In some cases, the SIB broadcasts may include information indicating that the NH-RAN 904 is a NH-RAN and/or identifying the NH-RAN 904. In some cases, the SIB may be transmitted periodically by the NH-RAN 804. In other cases, the SIB may be transmitted on demand (e.g., in response to a request by a UE, such as the W-UE 802) by the NH-RAN 804. At step 914, the W-UE 902 may determine to access the NH-RAN 904 for PoC witnessing operations. In some cases, the W-UE 902 may determine to access the NH-RAN 904 based on a comparison between transmissions from the NH-RAN 904, such as the SIB broadcast at step 912, to the configuration information. In some cases, the W-UE 902 may determine to access the NH-RAN 904 based on the information indicating that the NH-RAN 904 is a NH-RAN and/or identifying the NH-RAN 904.

Based on the determination to access the NH-RAN 904, the W-UE 902 may transmit a RACH msg1 including the W-UE PoC token to the NH-RAN 904 at step 916. The NH-RAN 904 may then check, at step 918, to see if the W-UE 902 is authorized to perform PoC operations (e.g., PoC witnessing operations and transmitting PoC reports via the NH-RAN 904). For example, the NH-RAN 904 may check if the W-UE 902 is authorized to perform PoC operations based on a comparison between the W-UE PoC token included in the RACH msg1 sent to the NH-RAN 904 at step 916 with the range of W-UE tokens indicated by the PoC NF 906 in step 908. If the W-UE PoC token is validated, the NH-RAN 904 may transmit, at step 920, a RACH msg2 to the W-UE 902. The RACH msg2 may include the NH-RAN PoC token along with a UL resources grant for the PoC report.

At step 922, the W-UE 902 may generate a PoC report about the NH-RAN 904 in a manner substantially similar to that discussed with respect to FIG. 8. The PoC report may include the NH-RAN POC token and/or the W-UE PoC token. In some cases, the W-UE 902 may encrypt the PoC report based on the security materials received from the PoC NF 906, for example, at step 910. At step 924, the W-UE 902 may transmit a RACH msg3 with the PoC report to the NH-RAN 904. The RACH msg3 may be transmitted using the UL resources granted.

At step 926, the NH-RAN 904 may transmit the PoC report to the PoC NF 906. In some cases, the NH-RAN 904 may also transmit a NH-RAN PoC report to the PoC NF 906. The NH-RAN PoC report may include the NH-RAN PoC token as well as the W-UE PoC token. In some cases, the PoC reports may be transmitted via an IP connected between the NH-RAN 904 and PoC NF 906. In some cases, a protocol for transmitting messages between the NH-RAN 904 and PoC NF 906 may be defined. In some cases, this protocol may be a service based interface and the PoC NF 906 may expose APIs for transmitting the PoC reports to the PoC NF 906. In some cases, the PoC NF 906 may verify the PoC report from the W-UE 902 and the NH-RAN PoC report. In some cases, the PoC NF 906 may verify that the W-UE PoC token and NH-RAN PoC token are valid and the tokens match from the report from W-UE 902 and NH-RAN 904 respectively.

After transmitting the PoC report, at step 928, the NH-RAN may transmit a RACH msg4 to the W-UE 902 indicating that the PoC report was successfully sent to the PoC NF 906. In some cases, as the W-UE 902 may not be authorized to connect to (e.g., camp or enter an RRC connected state or connected mode) the NH-RAN 904, the RACH msg4 may also include a release to the W-UE 902 releasing the W-UE 902. In some cases, the W-UE 902 may be an active UE. In cases where the W-UE 902 is an active UE, the RACH msg4 may not include the release. In some cases, as the PoC report is sent to the PoC NF 906 and on to the NH-RAN 904 during a RACH procedure, a maximum allowed time window may not be needed as the RACH messages (e.g., RACH msg1-msg4) should be completed during a relatively short period of time.

In some cases, if the W-UE 902 sends a PoC report for a NH-RAN different from the current NH-RAN 904, the PoC NF 906 may record the PoC report as an invalid report and may invalidate the W-UE 902 so as to block PoC witnessing operations by the W-UE 902. In some cases, the PoC NF 906 may configure an offset time for the W-UE in a manner substantially similar to that discussed above with respect to FIG. 8.

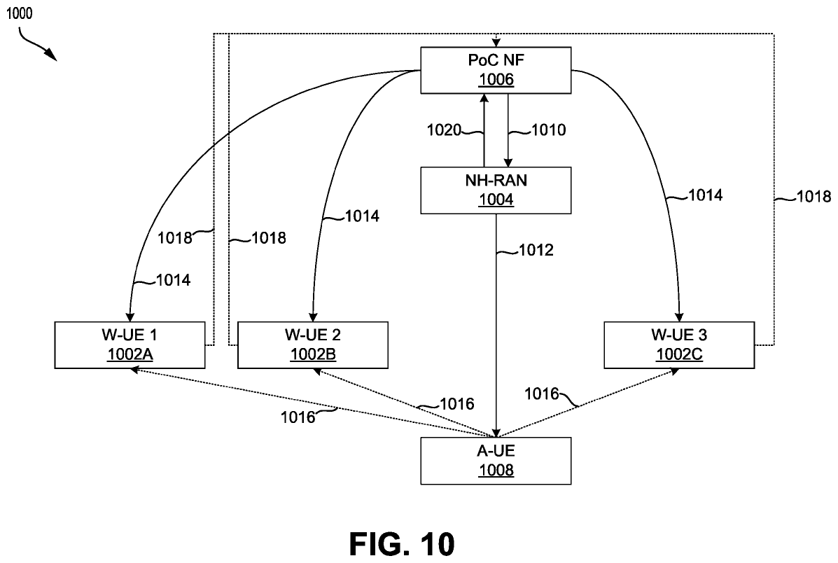

FIG. 10 is a block diagram illustrating an example sidelink (SL) assisted witnessing operation 1000, in accordance with aspects of the present disclosure. The SL assisted witnessing operation 1000 may be an upper layer (e.g., layer 4+) solution. In some cases, the SL assisted witnessing operation 1000 may be performed using any type of P2P or D2D link. In some cases, the SL link may be cellular based. In other cases, the SL link may be based on other radio access technologies, such as Wi-Fi, Bluetooth, and the like. In this example SL assisted witnessing operation 1000, three W-UEs 1002A, 1002B, and 1002C (collectively W-UEs 1002) may perform PoC witnessing operations on a NH-RAN 1004 (e.g., a NG-RAN node) and report to a PoC NF 1006. A PoC NF 1006 may determine to perform a SL assisted witnessing operation if the PoC NF 1006 has detected an A-UE 1008 camping (e.g., in a RRC connected state) on the NH-RAN 1004. In some cases, a NH-RAN 1004 may report 1020 to the PoC NF 1006 when a A-UE, such as A-UE 1008, camps on the NH-RAN 1004. In some cases, this report 1020 may include information about the A-UE 1008, such as a layer 2 identifier associated with the A-UE 1008. The PoC NF 1006 may detect the A-UE 1008 camping on the NH-RAN 1004 based on this report 1020. The PoC NF 1006 may verify this report 1020 using the SL assisted witnessing operation 1000.

In some cases, the PoC NF 1006 may transmit 1010 a verification code and a timer to the NH-RAN 1004. The NH-RAN 1004 may forward 1012 the verification code to the A-UE 1008. The NH-RAN 1004 may also configure (e.g., provide sidelink configuration information) the A-UE 1008 with sidelink resources, such as a power, time, and/or frequency resources, to transmit the verification code to the W-UEs 1002. In some cases, the PoC NF 1006 may also select a plurality of W-UEs 1002 to perform the SL assisted witnessing operation. Multiple W-UEs 1002 may be used to determine a location of the NH-RAN 1004. For example, three W-UEs 1002 may be used to triangulate the location of the NH-RAN 1004 based on the locations of the W-UEs 1002. In some cases, the plurality of W-UEs 1002 may be selected based on a location of the W-UEs 1002 in a manner substantially similar to that discussed above with respect to FIG. 8. The PoC NF 1006 may configure 1014 the selected W-UEs 1002 with sidelink resources, such as a power, time, and/or frequency resources, that may be monitored for a transmission from the A-UE 1008. In some cases, the sidelink resources may be the sidelink resource block or a frequency band in which sidelink may be performed. In some cases, when a frequency band is configured for the sidelink resources, the sidelink resource blocks may be configured, within the frequency band, by the NH-RAN 1004.

The A-UE 1008 may transmit a SL message 1016 using the configured sidelink resources. In some cases, the SL message 1016 may be broadcast by the A-UE 1008. The SL message 1016 may include the verification code along with a layer 2 ID code associated with the A-UE 1008. After receiving the SL message 1016, the W-UEs 1002 may generate PoC verification reports. The PoC verification reports may include the verification code from the A-UE 1008, along with a time stamp, sidelink radio information measurements, and location information indicating a location of the W-UEs 1002. The W-UEs 1002 may transmit 1018 the PoC verification reports to the PoC NF 1006. In some cases, the W-UEs 1002 may transmit 1018 the PoC verification reports to the PoC NF 1006 in a manner substantially similar to that discussed with respect to FIGS. 8 and 9. In some cases, the W-UEs 1002 may be other A-UEs with respect to the NH-RAN 1004. The PoC NF 1006 may then correlate the PoC verification reports received from the W-UEs 1002 with the report 1020 received from the NH-RAN 1004, for example, by verifying the layer 2 identifier and the verification code. The PoC NF 1006 may also verify a location of the NH-RAN 1004 based on the location information from the W-UEs 1002. In some cases, the sidelink radio information measurements may provide an indication of how far the W-UEs 1002 are from the A-UE 1008. Examples of sidelink radio information measurements may include an RSRP, RSSI, RSRQ, channel quality indicator, SSB, sidelink control information, positioning information, such as zone area identifiers or GNSS information, or any combination thereof. In some cases, the PoC NF 1006 may estimate a distance between the A-UE 1008 and W-UEs 1002 based on the sidelink radio information measurements. In some cases, the PoC NF 1006 may evaluate a trustworthiness of the W-UEs 1002 based on the sidelink radio information measurements.

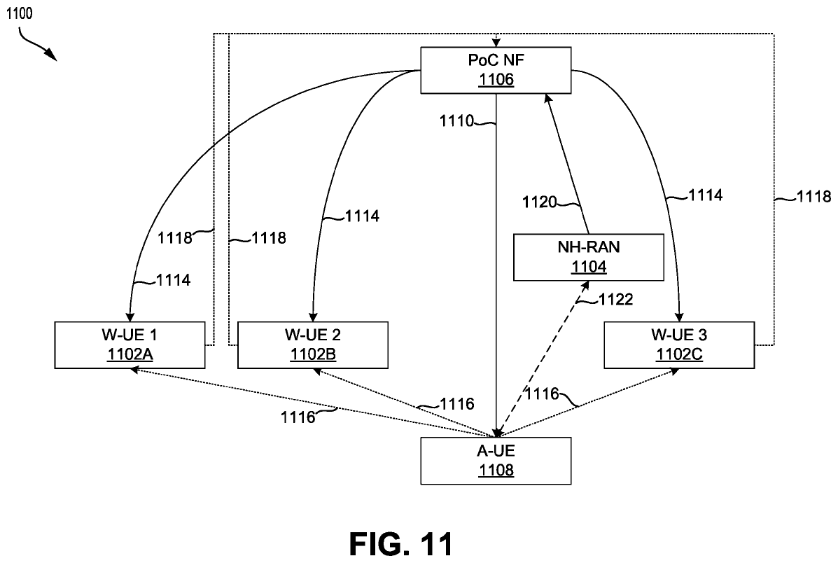

FIG. 11 is a block diagram illustrating an example direct connectivity assisted witnessing operation 1100, in accordance with aspects of the present disclosure. The direct connectivity assisted witnessing operation 1100 may be an upper layer (e.g., layer 4+) solution. In this example the direct connectivity assisted witnessing operation 1100, three W-UEs 1102A, 1102B, and 1102C (collectively W-UEs 1102) may perform PoC witnessing operations on a NH-RAN 1104 (e.g., a NH-RAN node) and report to a PoC NF 1106. In some cases, the direct connectivity assisted witnessing operation 1100 may be performed where there is a direct connection from the PoC NF 1106 to an A-UE 1008. This direct connection may be via a separate RAT as compared to a RAT used to connect the NH-RAN 1104 to the A-UE 1108. For example, the A-UE 1108 may connect to and camp on the NH-RAN 1104 using a cellular based RAT, such as 5G, LTE, and the like. The A-UE 1108 may also be communicatively coupled to PoC NF 1106 via another RAT, such as Wi-Fi, Bluetooth, and the like.

In some cases, the PoC NF 1106 may determine to perform a direct connectivity assisted witnessing operation if the PoF NF 1106 has detected that the A-UE 1108 is camping 1122 (e.g., in a RRC connected state) on the NH-RAN 1104. In some cases, a NH-RAN 1104 may report 1120 to the PoC NF 1106 when a A-UE, such as A-UE 1108, camps 1122 on the NH-RAN 1104. In some cases, this report 1120 may include information about the A-UE 1108, such as a layer 2 identifier associated with the A-UE 1102. The PoF NF 1106 may detect the A-UE 1108 camping on the NH-RAN 1104 based on this report 1120. The PoC NF 1106 may verify this report 1120 using the direct connectivity assisted witnessing operation 1100.

In some cases, the PoC NF 1106 may transmit 1110 a verification code to the NH-RAN 1104 via the direct connection. In some cases, the verification code may be a universal unique identifier (UUID). In some cases, the PoC NF 1106 may also configure (e.g., provide sidelink configuration information) A-UE 1108 with sidelink resources, such as a transmit power, validity time, and/or type of RAT, to use for transmitting to the W-UEs 1102. In some cases, the PoC NF 1106 may also select a plurality of W-UEs 1102 to perform the SL assisted witnessing operation. Multiple W-UEs 1102 may be used to determine a location of the NH-RAN 1104. For example, three W-UEs 1102 may be used to triangulate the location of the NH-RAN 1104 based on the locations of the W-UEs 1102. In some cases, the plurality of W-UEs 1102 may be selected based on a location of the W-UEs 1102 in a manner substantially similar to that discussed above with respect to FIG. 8. The PoC NF 1006 may configure 1114 the selected W-UEs 1102 with the UUID of the A-UE 1108 along with sidelink resources, such as the validation time, sidelink radio information measurements to perform, and/or type of RAT that may be monitored for a transmission from the A-UE 1108.

The A-UE 1108 may transmit a SL message 1116 as a sidelink transmission using the configured sidelink resources. In some cases, the SL message 1016 may be broadcast by the A-UE 1108. The SL message 1116 may include the verification code along with a layer 2 ID code associated with the A-UE 1108. Other UEs, such as W-UEs 1102 may listen for and receive sidelink transmission by other UEs, such as A-UE 1108, for example, based on configuration information from the PoC NF 1006. After receiving the SL message 1116, the W-UEs 1102 may generate PoC verification reports (e.g., coverage report). The PoC verification reports may include the verification code from the A-UE 1108, along with a time stamp, sidelink radio information measurements, and location information indicating a location of the W-UEs 1102. The W-UEs 1102 may transmit 1118 the PoC verification reports to the PoC NF 1106. In some cases, the W-UEs 1102 may transmit 1118 the PoC verification reports to the PoC NF 1006 in a manner substantially similar to that discussed with respect to FIGS. 8 and 9. In some cases, the W-UEs 1102 may be other A-UEs with respect to the NH-RAN 1104. The PoC NF 1106 may then correlate the PoC verification reports received from the W-UEs 1102 with the report 1120 received from the NH-RAN 1104, for example, by verifying the layer 2 identifier and the verification code. The PoC NF 1106 may also verify a location of the NH-RAN 1104 based on the location information from the W-UEs 1102. In some cases, the sidelink radio information measurements may provide an indication of how far the W-UEs 1102 are from the A-UE 1108. In some cases, the PoC NF 1106 may estimate a distance between the A-UE 1108 and W-UEs 1102 based on the sidelink radio information measurements. In some cases, the PoC NF 1106 may evaluate a trustworthiness of the W-UEs 1102 based on the sidelink radio information measurements.

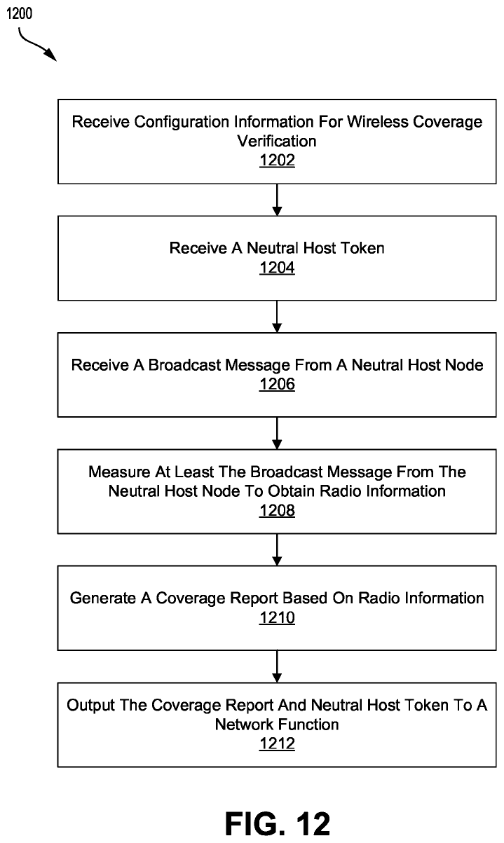

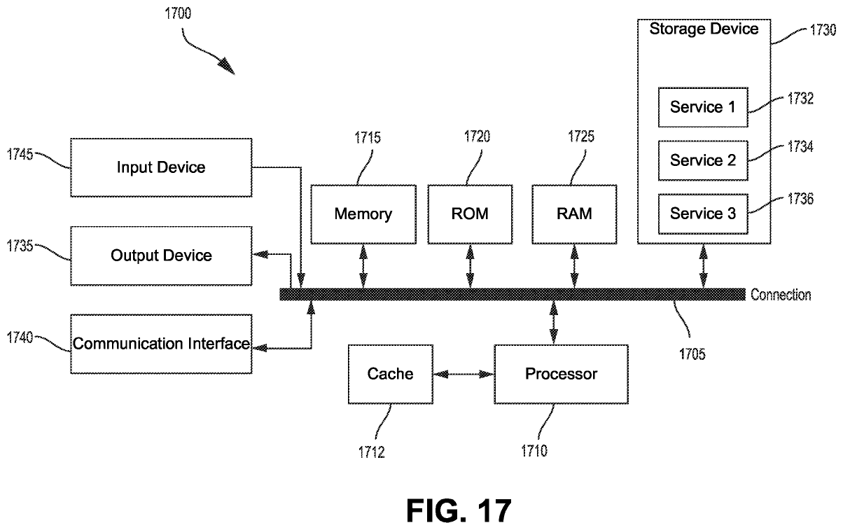

FIG. 12 is a flow diagram of a process 1200 for verifying coverage in wireless systems, in accordance with aspects of the present disclosure. The process 1200 may be performed by a computing device (or apparatus) or a component (e.g., a chipset, codec, etc.) of the computing device. The computing device may be a mobile device (e.g., a mobile phone), a UE (e.g., UE 104 of FIG. 1, wireless device 407 of FIG. 4, UE 602 of FIG. 6, W-UE 708 of FIG. 7, W-UE 802 of FIG. 8, and/or W-UE 902 of FIG. 9), a network-connected wearable such as a watch, an extended reality (XR) device such as a virtual reality (VR) device or augmented reality (AR) device, a vehicle or component or system of a vehicle, or other type of computing device. The operations of the process 1200 may be implemented as software components that are executed and run on one or more processors (e.g., controller/processor 280 of FIG. 2, processor 484 of FIG. 4, and/or processor 1710 of FIG. 17). In some cases, the operations of the process 1200 can be implemented by a system having the architecture computing system 1700 of FIG. 17.

At block 1202, the computing device (or component thereof) may receive configuration information for wireless coverage verification. In some cases, the configuration information is received from the network function. In some cases, the configuration information includes an indication of at least one of: a time and/or frequency information, public land mobile network (PLMN) ID, or cell ID.

At block 1204, the computing device (or component thereof) may receive a neutral host token. In some cases, the broadcast message includes the neutral host token.

At block 1206, the computing device (or component thereof) may receive a broadcast message from a neutral host node. In some cases, the broadcast message comprises a system information block (SIB) message. In some examples, the computing device (or component thereof) may monitor for the SIB message based on the received configuration information. In some examples, the computing device (or component thereof) may receive, from the network function, a user equipment (UE) token. In some cases, the computing device (or component thereof) may determine to access the neutral host node based on the SIB message. In some examples, the computing device (or component thereof) may transmit a first initial access message to the neutral host node, the first initial access message including the UE token. In some cases, the computing device (or component thereof) may receive a second initial access message from the neutral host node, the second initial access message including the neutral host token.

At block 1208, the computing device (or component thereof) may measure at least the broadcast message from the neutral host node to obtain radio information. In some cases, the radio information includes at least one of a reference signal received power (RSRP), received signal strength indicator (RSSI), reference signal received quality (RSRQ), channel quality indicator, synchronization signal block (SSB) information, cell ID, or public land mobile network (PLMN) ID.

At block 1210, the computing device (or component thereof) may generate a coverage report based on the radio information.

At block 1212, the computing device (or component thereof) may output the coverage report and neutral host token to a network function. In some examples, to output the coverage report, the computing device (or component thereof), may transmit the coverage report and neutral host token to the neutral host node in a third initial access message. In some cases, the computing device (or component thereof) may receive a fourth initial access message indicating the coverage report was sent to the network function. In some cases, the fourth initial access message includes a release indication. In some examples, the computing device (or component thereof) may release a connection to the neutral host node based on the release indication.

In some examples, the processes described herein (e.g., process 1200 and/or other process described herein) may be performed by a computing device or apparatus (e.g., a UE or a base station). In another example, the process 1200 may be performed by a UE, such as UE 104 of FIG. 1, wireless device 407 of FIG. 4, UE 602 of FIG. 6, W-UE 708 of FIG. 7, W-UE 802 of FIG. 8, and/or W-UE 902 of FIG. 9. In another example, the process 1200 may be performed by a computing device with the computing system 1700 shown in FIG. 17.

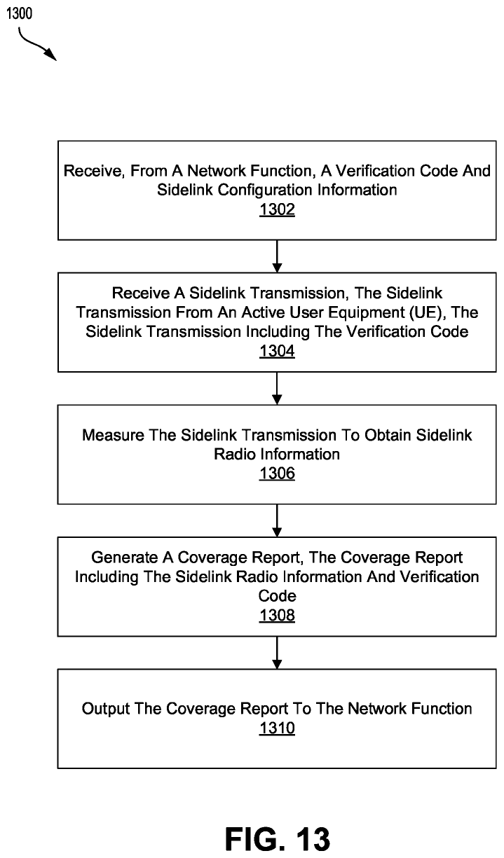

FIG. 13 is a flow diagram of a process 1300 for verifying coverage in wireless systems, in accordance with aspects of the present disclosure. The process 1300 may be performed by a computing device (or apparatus) or a component (e.g., a chipset, codec, etc.) of the computing device. The computing device may be a mobile device (e.g., a mobile phone), a UE (e.g., UE 104 of FIG. 1, wireless device 407 of FIG. 4, UE 602 of FIG. 6, W-UE 708 of FIG. 7, W-UE 1002 of FIG. 10, and/or W-UE 1102 of FIG. 11), a network-connected wearable such as a watch, an extended reality (XR) device such as a virtual reality (VR) device or augmented reality (AR) device, a vehicle or component or system of a vehicle, or other type of computing device. The operations of the process 1300 may be implemented as software components that are executed and run on one or more processors (e.g., controller/processor 280 of FIG. 2, processor 484 of FIG. 4, and/or processor 1710 of FIG. 17). In some cases, the operations of the process 1300 can be implemented by a system having the architecture computing system 1700 of FIG. 17.

At block 1302, the computing device (or component thereof) may receive, from a network function, a verification code and sidelink configuration information. In some cases, the computing device (or component thereof) may receive, from the network function, sidelink configuration information. In some cases, the computing device (or component thereof) may listen for the sidelink transmission based on the sidelink configuration information.

At block 1304, the computing device (or component thereof) may receive a sidelink transmission, the sidelink transmission from an active user equipment (UE), the sidelink transmission including the verification code. In some cases, the sidelink transmission includes an identifier for the active UE. In some cases, the coverage report includes the identifier for the active UE. In some cases, the sidelink transmission is performed using at least one of 5G direct mode, LTE Direct (LTE-D), Wi-Fi Direct (Wi-Fi-D), and Bluetooth.

At block 1306, the computing device (or component thereof) may measure the sidelink transmission to obtain sidelink radio information measurements. In some cases, the sidelink radio information measurements include at least one of a reference signal received power (RSRP), received signal strength indicator (RSSI), reference signal received quality (RSRQ), channel quality indicator, synchronization signal block (SSB) information, cell ID, and public land mobile network (PLMN) ID.

At block 1308, the computing device (or component thereof) may generate a coverage report, the coverage report including the sidelink radio information measurements and verification code. At block 1310, the computing device (or component thereof) may output the coverage report to the network function.

In some examples, the processes described herein (e.g., process 1300 and/or other process described herein) may be performed by a computing device or apparatus (e.g., a UE or a base station). In another example, the process 1300 may be performed by a UE, such as UE 104 of FIG. 1, wireless device 407 of FIG. 4, UE 602 of FIG. 6, W-UE 708 of FIG. 7, W-UE 1002 of FIG. 10, and/or W-UE 1102 of FIG. 11. In another example, the process 1300 may be performed by a computing device with the computing system 1700 shown in FIG. 17.

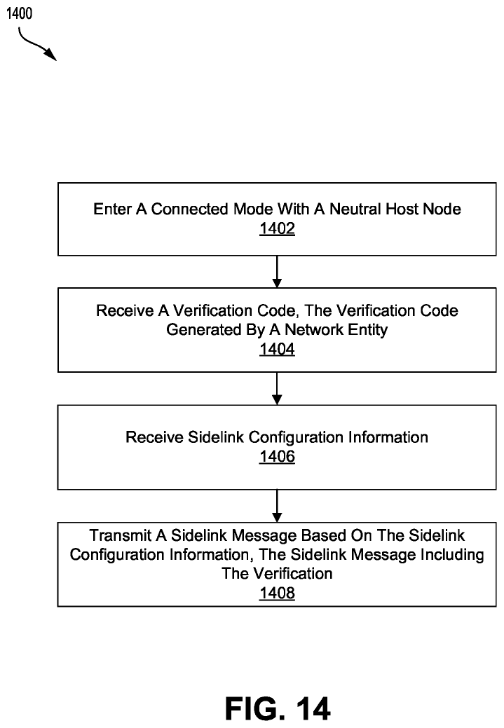

FIG. 14 is a flow diagram of a process 1400 for verifying coverage in wireless systems, in accordance with aspects of the present disclosure. The process 1400 may be performed by a computing device (or apparatus) or a component (e.g., a chipset, codec, etc.) of the computing device. The computing device may be a mobile device (e.g., a mobile phone), a UE (e.g., UE 104 of FIG. 1, wireless device 407 of FIG. 4, UE 602 of FIG. 6, W-UE 708 of FIG. 7, A-UE 1008 of FIG. 10, and/or A-UE 1108 of FIG. 11), a network-connected wearable such as a watch, an extended reality (XR) device such as a virtual reality (VR) device or augmented reality (AR) device, a vehicle or component or system of a vehicle, or other type of computing device. The operations of the process 1400 may be implemented as software components that are executed and run on one or more processors (e.g., controller/processor 280 of FIG. 2, processor 484 of FIG. 4, and/or processor 1710 of FIG. 17). In some cases, the operations of the process 1400 can be implemented by a system having the architecture computing system 1700 of FIG. 17.

At block 1402, the computing device (or component thereof) may enter a connected mode with a neutral host node.

At block 1404, the computing device (or component thereof) may receive a verification code, the verification code generated by a network entity. In some cases, the verification code is received from the neutral host node. In some cases, the verification code is received directly from the network entity. In some cases, the verification code is a universal unique identifier (UUID).

At block 1406, the computing device (or component thereof) may receive sidelink configuration information. In some cases, the sidelink configuration information includes at least power, time, frequency resources, and type of radio access technology.

At block 1408, the computing device (or component thereof) may transmit a sidelink message based on the sidelink configuration information, the sidelink message including the verification code. In some cases, the sidelink message further includes an identifier for the apparatus. In some cases, the sidelink message is transmitted using at least one of a 5G direct mode, LTE Direct (LTE-D), Wi-Fi Direct (Wi-Fi-D), and Bluetooth.

In some examples, the processes described herein (e.g., process 1400 and/or other process described herein) may be performed by a computing device or apparatus (e.g., a UE or a base station). In another example, the process 1400 may be performed by a UE, such as UE 104 of FIG. 1, wireless device 407 of FIG. 4, UE 602 of FIG. 6, W-UE 708 of FIG. 7, A-UE 1008 of FIG. 10, and/or A-UE 1108 of FIG. 11. In another example, the process 1400 may be performed by a computing device with the computing system 1700 shown in FIG. 17.

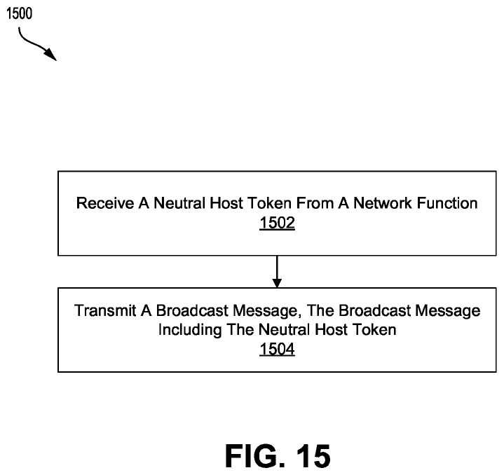

FIG. 15 is a flow diagram of a process 1500 for verifying coverage in wireless systems, in accordance with aspects of the present disclosure. The process 1500 may be performed by a computing device (or apparatus) or a component (e.g., a chipset, codec, etc.) of the computing device. The computing device may be a network entity (e.g., BS 102 of FIG. 2, mmW BS 180 of FIG. 1, neutral host network 604 of FIG. 6, NH-RAN 704 of FIG. 7, and/or NH-RAN 804 of FIG. 8) or other type of computing device. The operations of the process 1500 may be implemented as software components that are executed and run on one or more processors (e.g., controller/processor 280 of FIG. 2, processor 484 of FIG. 4, and/or processor 1710 of FIG. 17). In some cases, the operations of the process 1400 can be implemented by a system having the architecture computing system 1700 of FIG. 17.

At block 1502, the computing device (or component thereof) may receive a neutral host token from a network function.

At block 1504, the computing device (or component thereof) may transmit a broadcast message, the broadcast message including the neutral host token. In some cases, the broadcast message comprises a system information block (SIB) message.

In some examples, the processes described herein (e.g., process 1500 and/or other process described herein) may be performed by a computing device or apparatus (e.g., a UE or a base station). In another example, the process 1500 may be performed by a network entity, such as BS 102 of FIG. 2, mmW BS 180 of FIG. 1, neutral host network 604 of FIG. 6, NH-RAN 704 of FIG. 7, and/or NH-RAN 804 of FIG. 8. In another example, the process 1500 may be performed by a computing device with the computing system 1700 shown in FIG. 17.

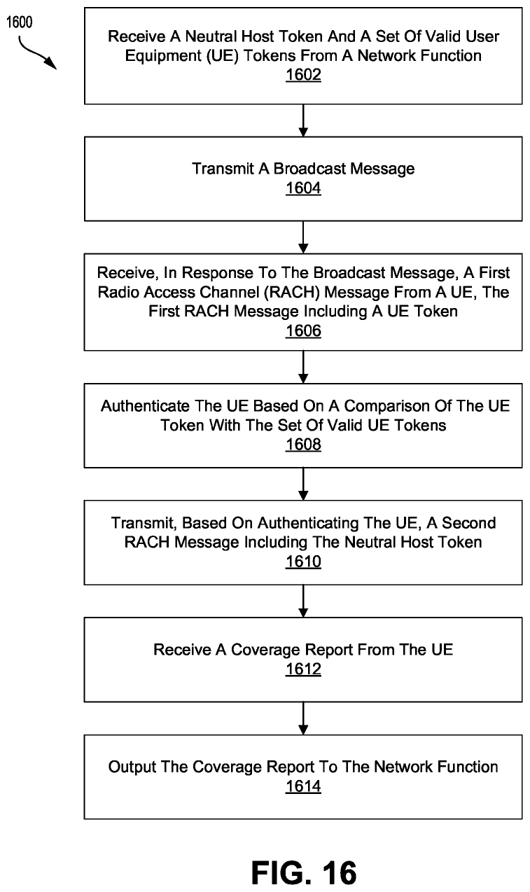

FIG. 16 is a flow diagram of a process 1600 for verifying coverage in wireless systems, in accordance with aspects of the present disclosure. The process 1600 may be performed by a computing device (or apparatus) or a component (e.g., a chipset, codec, etc.) of the computing device. The computing device may be a network entity (e.g., BS 102 of FIG. 2, mmW BS 180 of FIG. 1, neutral host network 604 of FIG. 6, NH-RAN 704 of FIG. 7, and/or NH-RAN 904 of FIG. 9) or other type of computing device. The operations of the process 1600 may be implemented as software components that are executed and run on one or more processors (e.g., controller/processor 280 of FIG. 2, processor 484 of FIG. 4, and/or processor 1710 of FIG. 17). In some cases, the operations of the process 1600 can be implemented by a system having the architecture computing system 1700 of FIG. 17.

At block 1602, the computing device (or component thereof) may receive a neutral host token and a set of valid user equipment (UE) tokens from a network function.

At block 1604, the computing device (or component thereof) may transmit a broadcast message.

At block 1606, the computing device (or component thereof) may receive, in response to the broadcast message, a first radio access channel (RACH) message from a UE, the first RACH message including a UE token.

At block 1608, the computing device (or component thereof) may authenticate the UE based on a comparison of the UE token with the set of valid UE tokens.

At block 1610, the computing device (or component thereof) may transmit, based on authenticating the UE, a second RACH message including the neutral host token.

At block 1612, the computing device (or component thereof) may receive a coverage report from the UE. In some cases, to receive the coverage report, the computing device (or component thereof) may, receive a third RACH message from the UE.

At block 1614, the computing device (or component thereof) may output the coverage report to the network function. In some cases, the computing device (or component thereof) may transmit a message to the UE indicating the coverage report was sent to the network function. In some cases, the coverage report includes the neutral host token, and wherein the coverage report is encrypted.

In some examples, the processes described herein (e.g., process 1600 and/or other process described herein) may be performed by a computing device or apparatus (e.g., a UE or a base station). In another example, the process 1600 may be performed by a network entity, such as BS 102 of FIG. 2, mmW BS 180 of FIG. 1, neutral host network 604 of FIG. 6, NH-RAN 704 of FIG. 7, and/or NH-RAN 904 of FIG. 9. In another example, the process 1600 may be performed by a computing device with the computing system 1700 shown in FIG. 17.

FIG. 17 is a diagram illustrating an example of a system for implementing certain aspects of the present technology. In particular, FIG. 17 illustrates an example of computing system 1700, which may be for example any computing device making up internal computing system, a remote computing system, a camera, or any component thereof in which the components of the system are in communication with each other using connection 1705. Connection 1705 may be a physical connection using a bus, or a direct connection into processor 1710, such as in a chipset architecture. Connection 1705 may also be a virtual connection, networked connection, or logical connection.

In some embodiments, computing system 1700 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1700 includes at least one processing unit (CPU or processor) 1710 and connection 1705 that communicatively couples various system components including system memory 1715, such as read-only memory (ROM) 1720 and random access memory (RAM) 1725 to processor 1710. Computing system 1700 may include a cache 1712 of high-speed memory connected directly with, in close proximity to, or integrated as part of processor 1710.

Processor 1710 may include any general purpose processor and a hardware service or software service, such as services 1732, 1734, and 1736 stored in storage device 1730, configured to control processor 1710 as well as a special-purpose processor where software instructions are incorporated into the actual processor design. Processor 1710 may essentially be a completely self-contained computing system, containing multiple cores or processors, a bus, memory controller, cache, etc. A multi-core processor may be symmetric or asymmetric.

To enable user interaction, computing system 1700 includes an input device 1745, which may represent any number of input mechanisms, such as a microphone for speech, a touch-sensitive screen for gesture or graphical input, keyboard, mouse, motion input, speech, etc. Computing system 1700 may also include output device 1735, which may be one or more of a number of output mechanisms. In some instances, multimodal systems may enable a user to provide multiple types of input/output to communicate with computing system 1700.

Computing system 1700 may include communications interface 1740, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an AppleTM Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1740 may also include one or more Global Navigation Satellite System (GNSS) receivers or transceivers that are used to determine a location of the computing system 1700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1730 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1730 may include software services, servers, services, etc., that when the code that defines such software is executed by the processor 1710, it causes the system to perform a function. In some embodiments, a hardware service that performs a particular function may include the software component stored in a computer-readable medium in connection with the necessary hardware components, such as processor 1710, connection 1705, output device 1735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“>”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:
Aspect 1. An apparatus for wireless communications, comprising: at least one memory comprising instructions; and at least one processor coupled to the at least one memory and configured to: receive configuration information for wireless coverage verification; receive a neutral host token; receive a broadcast message from a neutral host node; measure at least the broadcast message from the neutral host node to obtain radio information; generate a coverage report based on the radio information; and output the coverage report and neutral host token to a network function.
Aspect 2. The apparatus of Aspect 1, wherein the broadcast message includes the neutral host token.
Aspect 3. The apparatus of any of Aspects 1-2, wherein the radio information includes at least one of a reference signal received power (RSRP), received signal strength indicator (RSSI), reference signal received quality (RSRQ), channel quality indicator, synchronization signal block (SSB) information, cell ID, and public land mobile network (PLMN) ID.
Aspect 4. The apparatus of any of Aspects 1-3, wherein the configuration information is received from the network function.
Aspect 5. The apparatus of any of Aspects 1-4, wherein the configuration information includes an indication of at least one of: a time and/or frequency information, public land mobile network (PLMN) ID, and cell ID.
Aspect 6. The apparatus of any of Aspects 1-5, wherein the broadcast message comprises a system information block (SIB) message.
Aspect 7. The apparatus of Aspect 6, wherein the at least one processor is further configured to monitor for the SIB message based on the received configuration information.
Aspect 8. The apparatus of Aspect 6, wherein the at least one processor is further configured to: receive, from the network function, a user equipment (UE) token; determine to access the neutral host node based on the SIB message; and transmit a first initial access message to the neutral host node, the first initial access message including the UE token.
Aspect 9. The apparatus of Aspect 8, wherein the at least one processor is further configured to receive a second initial access message from the neutral host node, the second initial access message including the neutral host token.
Aspect 10. The apparatus of Aspect 8, wherein, to output the coverage report, the at least one processor is further configured to transmit the coverage report and neutral host token to the neutral host node in a third initial access message.
Aspect 11. The apparatus of Aspect 10, wherein the at least one processor is further configured to receive a fourth initial access message indicating the coverage report was sent to the network function.
Aspect 12. The apparatus of Aspect 11, wherein the fourth initial access message includes a release indication, and wherein the at least one processor is further configured to release a connection to the neutral host node.
Aspect 13. An apparatus for wireless communications, comprising: at least one memory comprising instructions; and at least one processor coupled to the at least one memory and configured to: receive, from a network function, a verification code and sidelink configuration information; receive a sidelink transmission, the sidelink transmission from an active user equipment (UE), the sidelink transmission including the verification code; measure the sidelink transmission to obtain sidelink radio information measurements; generate a coverage report, the coverage report including the sidelink radio information measurements and verification code; and output the coverage report to the network function.
Aspect 14. The apparatus of Aspect 13, wherein the at least one processor is further configured to: receive, from the network function, sidelink configuration information; and listen for the sidelink transmission based on the sidelink configuration information.
Aspect 15. The apparatus of any of Aspects 13-14, wherein the sidelink transmission includes an identifier for the active UE and wherein the coverage report includes the identifier for the active UE.
Aspect 16. The apparatus of any of Aspects 13-15, wherein the sidelink transmission is performed using at least one of 5G direct mode, LTE Direct (LTE-D), Wi-Fi Direct (Wi-Fi-D), and Bluetooth.
Aspect 17. The apparatus of any of Aspects 13-16, wherein the sidelink radio information measurements include at least one of a reference signal received power (RSRP), received signal strength indicator (RSSI), reference signal received quality (RSRQ), channel quality indicator, synchronization signal block (SSB) information, cell ID, and public land mobile network (PLMN) ID.
Aspect 18. An apparatus for wireless communications, comprising: at least one memory comprising instructions; and at least one processor coupled to the at least one memory and configured to: enter a connected mode with a neutral host node; receive a verification code, the verification code generated by a network entity; receive sidelink configuration information; and transmit a sidelink message based on the sidelink configuration information, the sidelink message including the verification code.
Aspect 19. The apparatus of Aspect 18, wherein the verification code is received from the neutral host node.
Aspect 20. The apparatus of any of Aspects 18-19, wherein the verification code is received directly from the network entity.
Aspect 21. The apparatus of any of Aspects 18-20, wherein the sidelink message further includes an identifier for the apparatus.
Aspect 22. The apparatus of any of Aspects 18-21, wherein the sidelink configuration information includes at least power, time, frequency resources, and type of radio access technology.
Aspect 23. The apparatus of any of Aspects 18-22, wherein the verification code is a universal unique identifier (UUID).
Aspect 24. The apparatus of any of Aspects 18-23, wherein the sidelink message is transmitted using at least one of a 5G direct mode, LTE Direct (LTE-D), Wi-Fi Direct (Wi-Fi-D), and Bluetooth.
Aspect 25. An apparatus for wireless communications, comprising: at least one memory comprising instructions; and at least one processor coupled to the at least one memory and configured to: receive a neutral host token from a network function; and transmit a broadcast message, the broadcast message including the neutral host token.
Aspect 26. The apparatus of Aspect 25, wherein the broadcast message comprises a system information block (SIB) message.
Aspect 27. An apparatus for wireless communications, comprising: at least one memory comprising instructions; and at least one processor coupled to the at least one memory and configured to: receive a neutral host token and a set of valid user equipment (UE) tokens from a network function; transmit a broadcast message; receive, in response to the broadcast message, a first radio access channel (RACH) message from a UE, the first RACH message including a UE token; authenticate the UE based on a comparison of the UE token with the set of valid UE tokens; transmit, based on authenticating the UE, a second RACH message including the neutral host token: receive a coverage report from the UE; and output the coverage report to the network function.
Aspect 28. The apparatus of Aspect 27, wherein, to receive the coverage report, the at least one processor is configured to receive a third RACH message from the UE.
Aspect 29. The apparatus of any of Aspects 27-28, wherein the at least one processor is further configured to transmit a message to the UE indicating the coverage report was sent to the network function.
Aspect 30. The apparatus of any of Aspects 27-29, wherein the coverage report includes the neutral host token, and wherein the coverage report is encrypted.
Aspect 31. A method for wireless communications, comprising: receiving configuration information for wireless coverage verification; receiving a neutral host token; receiving a broadcast message from a neutral host node; measuring at least the broadcast message from the neutral host node to obtain radio information; generating a coverage report based on the radio information; and outputting the coverage report and neutral host token to a network function.
Aspect 32. The method of Aspect 31, wherein the broadcast message includes the neutral host token.
Aspect 33. The method of any of Aspects 31-32, wherein the radio information includes at least one of a reference signal received power (RSRP), received signal strength indicator (RSSI), reference signal received quality (RSRQ), channel quality indicator, synchronization signal block (SSB) information, cell ID, and public land mobile network (PLMN) ID.
Aspect 34. The method of any of Aspects 31-33, wherein the configuration information is received from the network function.
Aspect 35. The method of any of Aspects 31-34, wherein the configuration information includes an indication of at least one of: a time and/or frequency information, public land mobile network (PLMN) ID, and cell ID.
Aspect 36. The method of any of Aspects 31-35, wherein the broadcast message comprises a system information block (SIB) message.
Aspect 37. The method of Aspect 36, further comprising monitoring for the SIB message based on the received configuration information.
Aspect 38. The method of Aspect 36, further comprising: receiving, from the network function, a user equipment (UE) token; determining to access the neutral host node based on the SIB message; and transmitting a first initial access message to the neutral host node, the first initial access message including the UE token.
Aspect 39. The method of Aspect 38, further comprising receiving a second initial access message from the neutral host node, the second initial access message including the neutral host token.
Aspect 40. The method of Aspect 38, wherein outputting the coverage report comprises transmitting the coverage report and neutral host token to the neutral host node in a third initial access message.
Aspect 41. The method of Aspect 40, further comprising receiving a fourth initial access message indicating the coverage report was sent to the network function.
Aspect 42. The method of Aspect 41, wherein the fourth initial access message includes a release indication, and further comprising releasing a connection to the neutral host node.
Aspect 43. A method for wireless communications, comprising: receiving, from a network function, a verification code and sidelink configuration information; receiving a sidelink transmission, the sidelink transmission from an active user equipment (UE), the sidelink transmission including the verification code; measuring the sidelink transmission to obtain sidelink radio information measurements; generating a coverage report, the coverage report including the sidelink radio information measurements and verification code; and outputting the coverage report to the network function.
Aspect 44. The method of Aspect 43, further comprising: receiving, from the network function, sidelink configuration information; and listening for the sidelink transmission based on the sidelink configuration information.
Aspect 45. The method of any of Aspects 43-44, wherein the sidelink transmission includes an identifier for the active UE and wherein the coverage report includes the identifier for the active UE.
Aspect 46. The method of any of Aspects 43-45, wherein the sidelink transmission is performed using at least one of 5G direct mode, LTE Direct (LTE-D), Wi-Fi Direct (Wi-Fi-D), and Bluetooth.
Aspect 47. The method of any of Aspects 43-46, wherein the sidelink radio information measurements include at least one of a reference signal received power (RSRP), received signal strength indicator (RSSI), reference signal received quality (RSRQ), channel quality indicator, synchronization signal block (SSB) information, cell ID, and public land Mobile Network (PLMN) Id.
Aspect 48. A method for wireless communications, comprising: entering a connected mode with a neutral host node; receiving a verification code, the verification code generated by a network entity; receiving sidelink configuration information; and transmitting a sidelink message based on the sidelink configuration information, the sidelink message including the verification code.
Aspect 49. The method of Aspect 48, wherein the verification code is received from the neutral host node.
Aspect 50. The method of any of Aspects 48-49, wherein the verification code is received directly from the network entity.
Aspect 51. The method of any of Aspects 48-50, wherein the sidelink message further includes an identifier for an apparatus.
Aspect 52. The method of any of Aspects 48-51, wherein the sidelink configuration information includes at least power, time, frequency resources, and type of radio access technology.
Aspect 53. The method of any of Aspects 48-52, wherein the verification code is a universal unique identifier (UUID).
Aspect 54. The method of any of Aspects 48-54, wherein the sidelink message is transmitted using at least one of a 5G direct mode, LTE Direct (LTE-D), Wi-Fi Direct (Wi-Fi-D), and Bluetooth.
Aspect 55. A method for wireless communications, comprising: receiving a neutral host token from a network function; and transmitting a broadcast message, the broadcast message including the neutral host token.
Aspect 56. The method of Aspect 55, wherein the wherein the broadcast message comprises a system information block (SIB) message.
Aspect 57. A method for wireless communications, comprising: receiving a neutral host token and a set of valid user equipment (UE) tokens from a network function; transmitting a broadcast message; receiving, in response to the broadcast message, a first radio access channel (RACH) message from a UE, the first RACH message including a UE token; authenticating the UE based on a comparison of the UE token with the set of valid UE tokens; transmitting, based on authenticating the UE, a second RACH message including the neutral host token; receiving a coverage report from the UE; and outputting the coverage report to the network function.
Aspect 58. The method of Aspect 57, wherein receiving the coverage report comprises receiving a third RACH message from the UE.
Aspect 59. The method of any of Aspects 57-58, further comprising transmitting a message to the UE indicating the coverage report was sent to the network function.
Aspect 60. The method of any of Aspects 57-59, wherein the coverage report includes the neutral host token, and wherein the coverage report is encrypted.
Aspect 61. A non-transitory computer-readable medium having stored thereon instructions that, when executed by one or more processors, cause the at one or more processors to perform an operation according to any of Aspects 31-60.
Aspect 62. An apparatus comprising means for performing a method according to any of Aspects 31 to 60.

1. An apparatus for wireless communications, comprising:
at least one memory comprising instructions; and
at least one processor coupled to the at least one memory and configured to:
receive configuration information for wireless coverage verification; receive a neutral host token;
receive a broadcast message from a neutral host node;
measure at least the broadcast message from the neutral host node to obtain radio information;
generate a coverage report based on the radio information; and output the coverage report and neutral host token to a network function.

2. The apparatus of claim 1, wherein the broadcast message includes the neutral host token.

3. The apparatus of claim 1, wherein the radio information includes at least one of a reference signal received power (RSRP), received signal strength indicator (RSSI), reference signal received quality (RSRQ), channel quality indicator, synchronization signal block (SSB) information, cell ID, and public land mobile network (PLMN) ID.

4. The apparatus of claim 1, wherein the configuration information is received from the network function.

5. The apparatus of claim 1, wherein the configuration information includes an indication of at least one of: a time and/or frequency information, public land mobile network (PLMN) ID, and cell ID.

6. The apparatus of claim 1, wherein the broadcast message comprises a system information block (SIB) message.

7. The apparatus of claim 6, wherein the at least one processor is further configured to monitor for the SIB message based on the received configuration information.

8. The apparatus of claim 6, wherein the at least one processor is further configured to: receive, from the network function, a user equipment (UE) token;
determine to access the neutral host node based on the SIB message; and
transmit a first initial access message to the neutral host node, the first initial access message including the UE token.

9. The apparatus of claim 8, wherein the at least one processor is further configured to receive a second initial access message from the neutral host node, the second initial access message including the neutral host token.

10. The apparatus of claim 8, wherein, to output the coverage report, the at least one processor is further configured to transmit the coverage report and neutral host token to the neutral host node in a third initial access message.

11. The apparatus of claim 10. wherein the at least one processor is further configured to receive a fourth initial access message indicating the coverage report was sent to the network function.

12. The apparatus of claim 11. wherein the fourth initial access message includes a release indication, and wherein the at least one processor is further configured to release a connection to the neutral host node.

13. An apparatus for wireless communications, comprising:
at least one memory comprising instructions; and
at least one processor coupled to the at least one memory and configured to:
receive, from a network function, a verification code and sidelink configuration information;
receive a sidelink transmission, the sidelink transmission from an active user equipment (UE), the sidelink transmission including the verification code;
measure the sidelink transmission to obtain sidelink radio information measurements;
generate a coverage report, the coverage report including the sidelink radio information measurements and verification code; and
output the coverage report to the network function.

14. The apparatus of claim 13, wherein the at least one processor is further configured to:
receive, from the network function, sidelink configuration information; and listen for the sidelink transmission based on the sidelink configuration information.

15. The apparatus of claim 13. wherein the sidelink transmission includes an identifier for the active UE and wherein the coverage report includes the identifier for the active UE

16. The apparatus of claim 13, wherein the sidelink transmission is performed using at least one of 5G direct mode, LTE Direct (LTE-D), Wi-Fi Direct (Wi-Fi-D), and Bluetooth.

17. The apparatus of claim 13, wherein the sidelink radio information measurements include at least one of a reference signal received power (RSRP), received signal strength indicator (RS SI), reference signal received quality (RSRQ). channel quality indicator, synchronization signal block (SSB) information, cell ID, and public land mobile network (PLMN) ID.

18. An apparatus for wireless communications, comprising:
at least one memory comprising instructions; and
at least one processor coupled to the at least one memory and configured to:
enter a connected mode with a neutral host node;
receive a verification code, the verification code generated by a network entity;
receive sidelink configuration information; and
transmit a sidelink message based on the sidelink configuration information, the sidelink message including the verification code.

19. The apparatus of claim 18. wherein the verification code is received from the neutral host node.

20. The apparatus of claim 18, wherein the verification code is received directly from the network entity.

21.-30. (canceled)
